(19) United States
(12) Patent Application Publication
(10) Pub. No.: US 2011/0122617 A1
(43) Pub. Date: May 26, 2011

(54) Retaining Frame Comprising at Least one Optical Element

(75) Inventors: Peter Frey, Heidenheim (DE); Ralf Vollmer, Ulm (DE)

(73) Assignee: OSRAM Gesellschaft mit beschränkter Haftung, München (DE)

(21) Appl. No.: 13/054,611

(22) PCT Filed: Jul. 8, 2009
(86) PCT No.: PCT/EP2009/058658

§ 371 Date: Jan. 18, 2011

(30) Foreign Application Priority Data
Jul. 16, 2008 (DE) 10 2008 033 416.2

(51) Int. Cl. F21V 7/00; G02B 7/02; B23P 17/00

(52) U.S. Cl. 362/235; 359/811; 29/530

(57) ABSTRACT

A retaining frame (2; 17) with at least one optical element (3) secured thereto, wherein the at least one optical element (3) is connected to the retaining frame (2; 17) by calking, gluing in place, snap-fitting, clamping, shrinking, ultrasonic welding or pressing-in.

The invention relates to a retaining frame with at least one optical element secured thereto, a method for mounting an optical element to a retaining frame and an illumination device, especially a vehicle headlight module, with a retaining frame.

US 2005/0128762 A1 describes an illumination device comprising a lens support and a glass lens which is designed to be disposed in front of a light source, with the lens (an optical element forming an image by means of refraction) being assembled with the lens support which is attached to the light source, with the support being manufactured from a plastic material, with the lens having a rear side which is embodied to point in the direction of the light source, as well as an optical front side and a peripheral edge, which connects the rear side and the front side, with the lens support engaging with the lens at the edge, with the lamp being characterized by the support being attached to the lens by insert molding, with the material of which the support consists at least partly surrounding the edge of the lens.

The object of the present invention is to provide further options for retaining an optical element, especially for an illumination device, especially while further reducing the stress on the optical element to be accommodated.

This object is achieved by means of a retaining frame, a method for mounting an optical element and an illumination device, especially a vehicle headlight module according to the respective independent claim. Preferred forms of embodiment can especially be found in the independent claims.

The retaining frame is equipped with at least one (one or more) optical element(s) attached thereto. The at least one optical element is connected to the retaining frame by calking, gluing in place, snap-fitting, clamping, shrinking, ultrasonic welding or pressing-in.

In particular a retaining frame is preferred in which the at least one optical element is connected to the retaining frame by hot calking. In hot calking at least one part of the retaining frame is heated up enough for it to be slightly plastically deformable without its melting temperature being reached. This means that a predetermined shape of the retaining frame is maintained except for areas which are deformed under pressure. The at least one optical element is fixed to the retaining frame by deforming these areas. The advantage of hot calking is that the stresses to be overcome in such cases are small, so that the optical element is not significantly stressed. In addition hot calking can be used with little effort and at low cost. Its advantages compared to injection molding methods are the lower temperature level and the more rapid cooling to avoid thermal stresses on the optical element.

Especially preferred is a retaining frame consisting of a plastic, especially a thermoplastic, specifically PPS (“polyphenylene sulfide”, also called “poly(thio-p-phenylene)”), especially linear PPS. The good mechanical properties of PPS are maintained even at temperatures far above 200° C., so that long-term use up to 240° C., depending on stress, is possible. For short periods stresses at temperatures of up to 270° C. can also be withstood. Also outstanding is its chemical resistance to almost all solvents, many acids and alkalis as well as to an extent to atmospheric oxygen even at high temperatures. PPS, in addition to a lower water absorption, also has good dimensional stability and inherent flame resistance. It has outstanding electric insulating properties, is impermeable to a high degree to most liquids and gases, has a low creep tendency even at high temperatures and is suitable because of its good flow capabilities also for long, narrow molded parts and complex tool geometries. Linear PPS can, by contrast with cross-linked PPS, be molded to form components using a broad spectrum of processing methods.

For particularly effective reduction of scattered light a retaining frame is preferred in which an inner side of the wall which is intended to be directed towards the optical element has a light-absorbing surface structure.

For this purpose the wall can for example be roughened and/or coated with a light-absorbing coating for example.

For effective and all-around reduction of scattered light a retaining frame is further preferred which features a closed surrounding wall for lateral enclosure of the optical element.

In general the optical element can be any element for beam guidance for example an optical element based on refraction, e.g. a lens. However a retaining frame is preferred in which the at least one optical element for beam guidance is at least embodied by means of the inner total reflection and/or diffraction.

It is especially preferred for the least one optical element to have a CPC-type area, a CEC-type area and/or a CHC-type area. In particular a CPC-type concentrator can be employed in which case this is to be understood as a concentrator of which the reflecting sidewalls at least partly and/or at least substantially have the shape of a compound parabolic concentrator (CPC). A compound elliptic concentrator (CEC) and/or a compound hyperbolic concentrator (CHC) can also be used.

Especially preferred is the use of a free-form concentrator. A concentrator can, especially when used as the primary optics in a vehicle headlight module, preferably serve to throw light from a light source onto secondary optics and in doing so set a light distribution pattern, i.e. create a light/dark boundary.

As an alternative or in addition however it can be preferred for the optical element to have a truncated pyramidal area or a truncated conical area.

The retaining frame preferably features receptacle areas, especially recesses, to accommodate appropriate securing projections of the at least one optical element.

The method for mounting an optical element on a retaining frame has at least the following steps: Insertion of securing projections of the optical element into receptacle areas of the retaining frame and calking, especially hot calking, of flanging edges of the retaining frame above the securing projections.

The illumination device and thereby especially the vehicle headlight module is equipped with such a retaining frame and mostly features a semiconductor light source, especially light emitting diodes, which is connected downstream from the optical element, especially as the primary optics.

The optical element can consist of glass or transparent plastic, preferably silicon.

In the following figures the invention is described in greater detail in schematic diagrams which refer to exemplary embodiments. In the diagrams elements which are the same or which function in the same way can be provided with the same reference signs for greater clarity.

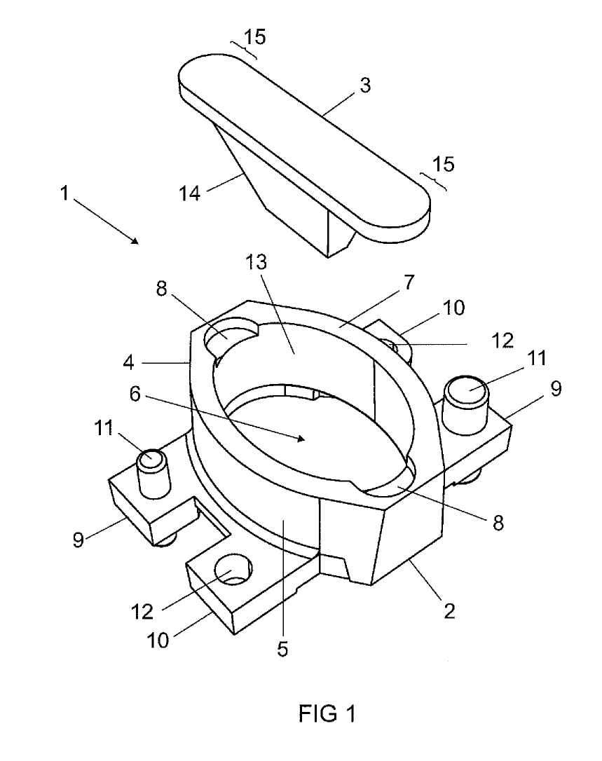

FIG. 1 shows an angled view from above of a frame in accordance with a first form of embodiment for an optical element, with the optical element to be supported therein separated therefrom;

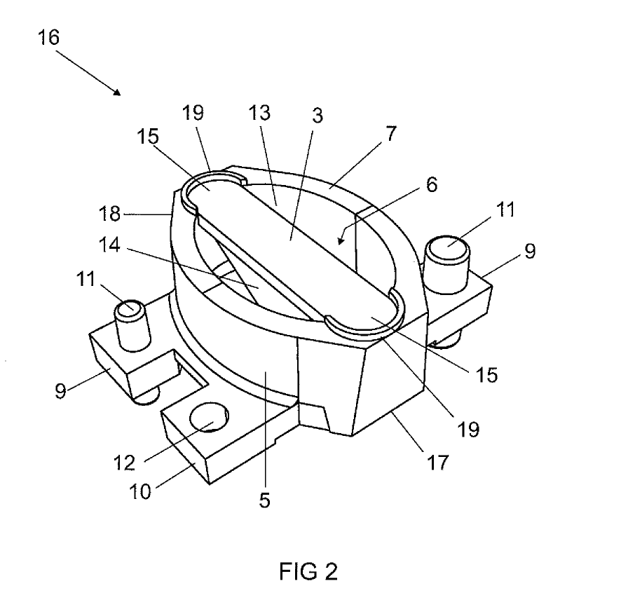

FIG. 2 shows an angled view from above of a frame in accordance with a second form of embodiment for an optical element, with an optical element inserted therein, but not yet attached;

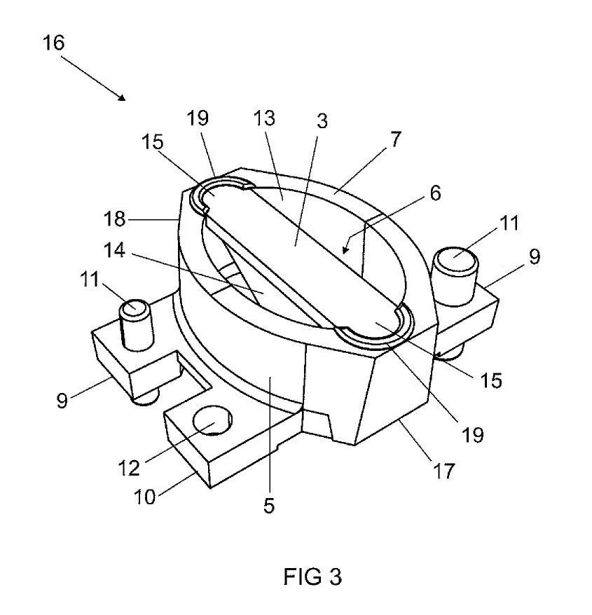

FIG. 3 shows an angled view from above of the system from FIG. 2 with the optical element secured thereto;

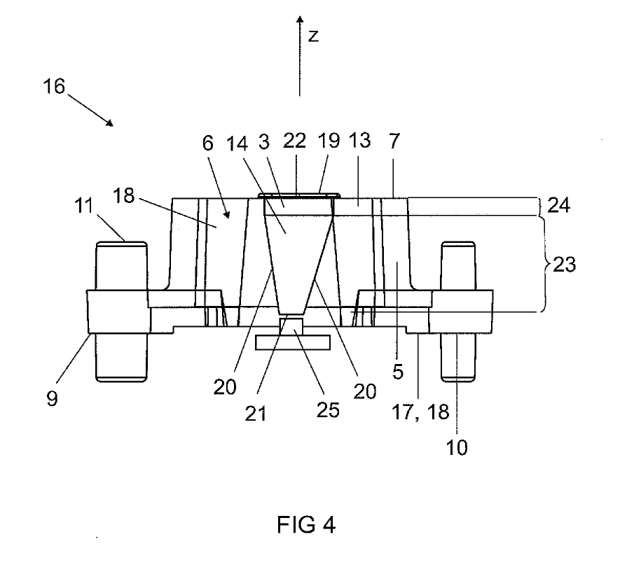

FIG. 4 shows an illumination device with a system in accordance with FIG. 3 in a cross-sectional view from the side.

FIG. 1 shows an optical system 1 with a retaining frame 2 and an optical element 3 to be secured to said frame. The optical system 1 is typically connected downstream from one or more light sources and is used for beam guidance of at least a part of the light emitted by the light source or the light sources respectively. The optical system 1 can be used for example as a part of an illumination device, especially an automobile light, e.g. a headlamp.

The retaining frame 2 has a hollow base member 4 open at the top and bottom which is formed by means of a closed surrounding thick wall 5 with a substantially oval continuous contour. The inner cavity 6 of the base member 4 formed by this serves to accommodate the optical element 3. For this purpose the base member has two receptacle areas on its upper edge 7 in the form of opposite recesses 8. In the lower area of the base member 4 there are four laterally projecting tabs 9, 10 to secure the retaining frame 2 to a light unit not shown in this diagram. To guide the retaining frame 2 two diagonally opposing tabs 9 have vertical guide pins 11 of which the lower part serves to position the retaining frame 2 and of which the upper part serves to position secondary optics. The other two tabs have through-holes 12 through which securing screws can be passed.

The retaining frame 2 is made of linear PPS. The PPS is darkened in order to minimize a light reflection on the retaining frame 2. This enables undesired scattered light hitting the retaining frame 2 to be suppressed. For further suppression of light reflection on the retaining frame 2 the inner side 13 of the base member 4 or of its wall 5 is roughened. Scattered light escaping laterally from the retaining frame 2 is suppressed by the closed surrounding shape of the wall 5.

The optical element 3 is embodied as total internal reflection (TIR) optics with an asymmetrical truncated pyramidal base member 14. Primary optics designed in this way make possible an efficient reduction of the divergence of light which in particular enables headlamps with sufficient brightness and well-defined beam characteristics to be achieved.

For securing it to the retaining frame 2 the optical element 3 has at least one corresponding securing area with two lateral tab-shaped projections 15. The projections essentially implement the securing function and only have a negligible influence on the optical property of the optical element 3. One advantage of securing the element only at the projections 15 also lies in the fact that a light-dark boundary is able to be well defined.

The optics system 1 is assembled by joining the optical element 3 to the frame 2 by gluing it in. The optical element 3 is positioned on the holder 2 by precise-fit insertion of the projections 15 into the recesses 8. A UV-hardening adhesive has been applied beforehand to the recesses 8 and/or the projections 14. To obtain an optimum adhesive joint, the gluing-in process is preceded by a plasma cleaning or activation process.

The optical element 3 is thus only secured by the projections 15 to the retaining frame 2, while the rest of the surface remains free. Because the projections 15 occupy a small surface area of the optical element 3 in the circumferential direction, a mechanical strain on the projections which could be caused by assembly only has a slight effect on the remaining volume of the optical element 3, since distortions in the material can be reduced at least partly by the free surface. Consequently even larger mechanical stresses on the projections 15 do not have a critical effect on the optical element 3. This “good stress behavior” is all the more marked the fewer projections 15 are used and the smaller the relative securing area.

FIG. 2 shows an optical system 16 with a retaining frame 17 in accordance with a further form of embodiment with an optical element 3 inserted into said frame but not yet secured to it. Integrated into the upper edge 7 of the base member 18 of the frame 17, enclosing the recesses, is a raised flanging edge 19. Since the TIR element 3 essentially makes a flush fit on the top side with the upper edge 7 the flanging edge 19 starts directly above the optical TIR element 3 and corresponds in its shape to the lateral delimitation of the recess.

FIG. 3 shows the optical element 3 secured to the frame 17. The element is securing by deforming the flanging edge 19 above the optical element 3 which in this exemplary embodiment is carried out by hot calking. Hot calking corresponds to calking a plastic material of the flanging edge 19 heated to below the melting point, since in this way a plastic deformation can be brought about while exerting little force. The optical element 3 is held stably at the desired position in the retaining frame 17 by the deformation.

Because the optical element 3 is only secured by means of the projections 15 to the retaining frame 2 the optics system 16 is tolerant of mechanical stresses. The remaining surface of the optical element 3 is not in contact with the retaining frame 2. When viewed along the inner cavity 6 from above or below, a free space remains, except for the projections 15, all around between the optical element 3 and the retaining frame 2. The optical element 2 thus does not close off the inner cavity 6. This “looser” arrangement makes it possible to use differently-shaped optical elements (concentrators, lenses, deflection grids, etc.) in the same retaining frame 2.

FIG. 4 shows the illumination device from FIG. 3 in cross section. This view shows that the optical element 3 (TIR concentrator) is not a symmetrical design. This means that the two side walls 20 slope at different angles, whereby direct connecting lines between a lower light entry surface 21 and an upper light exit surface 22 still run straight along them. Furthermore a non-widening extension area 24 adjoins the top of the truncated pyramidal area 23 of the optical element 3 on which the lateral tabs are also arranged. The flanging edges 19 hold the optical element 3 firmly at the edge of the upper light exit surface 22. The optical element 3 is surrounded along its longitudinal extent (in parallel to the z axis) to the side entirely by the retaining frame 17. From the cross-sectional diagram shown here it is evident on the narrower side of the optical element 3 that the optical element 2 fills out less than a third of the inner cavity 6 but occupies it over almost its entire length (in the z direction).

During operation light is fed from a light emitting diode 25 into the lower light entry surface 21 of the optical element 3, as is merely sketched out here. The light emitting diode 25, which is constructed here from a number of LED chips emitting white light attached to a common submount, is disposed so close to the lower light entry surface 21 that the greater part of the light emitted by it enters the lower light entry surface 21 and only a small part is emitted onto the inner side 13 of the wall 5 of the retaining frame 2. No light is emitted directly from the LED 25 through the free space between optical element 3 and wall 5. The light-absorbing property of the inner side 13 causes light falling thereon to be absorbed. Thus light is only emitted outwards (in this case upwards) by the optical element 3. Stated more precisely, light entering into the lower light entry surface 21 either passes directly through the optical element 3 to the upper light exit surface 22 from where it is emitted again; or light beams hitting the side walls 20 of the optical element 3 are reflected back into the optical element 3 by means of total inner reflection (TIR). This produces a desired illumination pattern with only small beam losses.

Naturally the present invention is not restricted to the exemplary embodiments shown.

Thus another, preferably thermoplastic, plastic can be used instead of PPS. This is preferably not transparent. The retaining frame too does not have to be made of plastic but can also feature metal for example.

The type of optical element is not restricted. Instead of the TIR concentrator with its essentially truncated pyramidal structure, a truncated conical basic design can also be used.

Instead of a TIP concentrator, a free-form CPC, CEC or CHC-type concentrator can also be employed, for example.

Deflection prisms can also generally be used.

As an alternative, refracting optical elements (such as lenses) and/or diffraction optical elements (such as a Fresnel zone plate or a diffraction grid) can also be held in the retaining frame.

It is also possible to use combined concentrator/diffraction optics, e.g. by attaching diffraction structures to a concentrator for example.

The optical element can have a microstructured surface for beam formation (e.g. a so-called pillow structure).

There is no limit to the number of securing areas, especially securing projections, of the optical element and the receptacle areas of the retaining frame. Thus more than two securing areas and associated receptacle areas can also be present or only one single securing and receptacle area, for example in the form of an edge running part of the way or all the way around the frame.

There can also be more receptacle areas available than projections.

Instead of gluing-in or calking, especially hot calking, other methods of securing can also be used, such as snapping-in by means of a snap-in connection for example, clamping by means of a spring clip for example, shrink fitting, ultrasound welding or pressing-on.

With a snap-in connection or with clamping, the projections of the optical element can especially be snapped into or clamped onto the retaining frame. This means that especially little assembly effort is required. Here too the mechanical stresses are able to be significantly reduced by using the projections and the otherwise free support.

For shrink-fitting, the retaining frame is preferably laid around the projections of the optical element and then caused to shrink, whereby the optical element is firmly seated by the projections. Shrink-fitting can be carried out by hot or cold joining and subsequent cooling down or heating up.

The securing projections can also be connected to the retaining frame by means of injection molding. Compared to complete all-around securing, e.g. by means of a securing edge running all around the frame, this firstly gives the advantage that thermal stress on the optical element is far lower and secondly that the connection is simpler to injection-mold. A further advantage of securing just with projections lies in the well-defined light-dark boundary.

The optical element can consist of glass or transparent plastic, especially of silicon.

Preferably the semiconductor light source comprises at least one light emitting diode. The light source can typically be present as an LED module with a light emitting diode chip or a number of light emitting diode chips, or as individual, housed LEDs (LED lamp) which preferably emit white light, e.g. a conversion LED. If there are a number of light emitting diodes present these can for example be the same color (monochrome or multicolor) and/or different colors. Thus an LED module may comprise a number of individual LED chips (LED cluster) which together produce a white mixed light, e.g. in cold white or warm white. To generate a white mixed light, the LED cluster preferably comprises light emitting diodes which emit light in the basic colors of red (R), green (G) and blue (B). In such cases individual colors or a number of colors can also be generated at the same time by a number of LEDs; thus combinations RGB, RRGB, RGBB, RGGBB etc. are possible. However the color combination is not restricted to R, G and B but can also include white-emitting LED chips for example. To create a warm white color tone, one or more amber-colored LEDs (A) can also be present for example. An LED module can also feature one or more white individual chips, which enables a simple scalability of the luminous flux to be achieved. The individual chips and/or the modules can be equipped with suitable optics for beam guidance, e.g. Fresnel lenses, collimators and so forth. A number of the same or different types of LED module can be arranged at one contact, e.g. a number of the same type of LED module on the same substrate. Instead of or in addition to inorganic light emitting diodes, e.g. based on InGaN or AlInGaP, organic LEDs (OLEDs) can also generally be used. Diode lasers can also be used for example.

### LIST OF REFERENCE SIGNS

1 Optics system

2 Retaining frame

3 Optical element

4 Base member

5 Wall

6 Inner cavity

7 Upper wall

8 Recess

9 Tab

10 Tab

11 Guide pin

12 Through-hole

13 Inner side of the wall

14 Base member of the optical element

15 Projection

16 Optics system

17 Retaining frame

18 Base member of the retaining frame

19 Flanging edge

20 Side wall

21 Lower light entry surface

22 Upper light exit surface

23 Truncated pyramidal area of the optical element

24 Expansion area

25 Light emitting diode

1. A retaining frame with at least one optical element secured thereto, wherein the at least one optical element is connected to the retaining frame by calking, gluing in place, snap-fitting, clamping, shrinking, ultrasonic welding or pressing-in.

2. The retaining frame as claimed in claim 1, wherein the at least one optical element is connected to the retaining frame by hot calking.

3. The retaining frame as claimed in claim 1, comprised of a thermoplastic plastic, especially PPS.

4. The retaining frame as claimed in claim 1, wherein the at least one optical element is embodied for beam formation by means of total inner reflection and/or diffraction.

5. The retaining frame as claimed in claim 4, wherein the optical element comprises a CPC-like area, a CEC-like area and/or a CHC-like area.

6. The retaining frame as claimed in claim 4, wherein the optical element has a truncated pyramidal area or a truncated conical area.

7. The retaining frame as claimed in claim 1, comprising receptacle areas for accepting suitable securing projections of the at least one optical element.

8. A method for mounting an optical element on a retaining frame as claimed in claim 7, comprising:
insertion of securing projections of the optical element in receptacle areas of the retaining frame and
calking of flanging edges of the retaining frame over the securing projections.

9. An illumination device with a retaining frame as claimed in claim 1, having at least one semiconductor light source connected downstream of the optical element.

10. The illumination device as claimed in claim 9, wherein the at least one optical element is connected downstream of the semiconductor light source as primary optics.

11. The retaining frame as claimed in claim 7, wherein said receptacle areas are recesses for accepting the suitable securing projections of the at least one optical element.

12. The illumination device as claimed in claim 9 wherein said at least one semiconductor light source is a light-emitting diode.
